(19) United States
(12) Patent Application Publication
(10) Pub. No.: US 2017/0370535 A1
(43) Pub. Date: Dec. 28, 2017

(54) EXTERNALLY-HUNG LAMP ASSEMBLY

(71) Applicant: Gong Fong Enterprise Co.,Ltd., Tainan (TW)

(72) Inventor: MING-CHIA WU, TAINAN (TW)

(21) Appl. No.: 15/229,097

(22) Filed: Aug. 4, 2016

(30) Foreign Application Priority Data
Jun. 23, 2016 (TW) 105209473

(51) Int. Cl. F21L 4/00; F21V 5/00; F21V 1/00; F21V 23/04; F21V 21/00; F21Y 2115/10

(52) U.S. Cl. CPC F21L 4/005; F21V 23/04; F21V 21/00; F21V 5/007; F21V 1/00; F21Y 2115/10

(57) ABSTRACT

An externally-hung lamp assembly includes a circuit board, a battery pack, an upper cover, a lampshade, a rubber ring, a lower cover, and a hook. The circuit board has a first hole and a plurality of light-emitting components. The battery pack is electrically connected to the circuit board and is configured to provide power needed for turning on the light-emitting components. The upper cover is disposed on the circuit board. The lampshade is disposed in a second hole of the upper cover. The rubber ring is disposed beneath the circuit board. The lower cover is combined with the upper cover, wherein the lower cover has a back surface. The hook is pivotally disposed on the back surface of the lower cover. By means of the foregoing configurations, the externally-hung lamp assembly can meet configuration requirements of multiple different application scenarios.

### FIELD

The disclosure relates to a lamp assembly, more particular to an externally-hung lamp assembly.

### BACKGROUND

It is known in the art that a lamp assembly structure is usually designed for a single application scenario. Although the lamp assembly structure can achieve an illumination effect, the lamp assembly structure cannot be applied to another application scenario. That is, different lamp assembly structures need to be configured for different application scenarios, and therefore, the cost of lamp assemblys is substantially increased. If a single lamp assembly structure can meet configuration requirements of different application scenarios, the cost of lamp assemblys can be substantially reduced.

### SUMMARY OF THE INVENTION

In accordance with one aspect of the present disclosure, an externally-hung lamp assembly includes a circuit board, a battery pack, an upper cover, a lampshade, a rubber ring, a lower cover, and a hook. The circuit board has a first hole and a plurality of light-emitting components. The battery pack is electrically connected to the circuit board and is configured to provide power needed for turning on the light-emitting components. The upper cover is disposed on the circuit board, wherein the upper cover has a second hole corresponding to the first hole of the circuit board. The lampshade is disposed in the second hole of the upper cover, wherein the lampshade has a third hole corresponding to the first hole of the circuit board. The rubber ring is disposed beneath the circuit board, wherein the rubber ring has a fourth hole corresponding to the first hole of the circuit board. The lower cover is combined with the upper cover, wherein the lower cover has a back surface and a fifth hole corresponding to the first hole of the circuit board. The hook is pivotally disposed on the back surface of the lower cover.

By means of the foregoing configurations, the externally-hung lamp assembly can meet configuration requirements of multiple different application scenarios.

### BRIEF DESCRIPTION OF THE DRAWINGS

Aspects of the present disclosure are understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates an exploded perspective view of an externally-hung lamp assembly in accordance with some embodiments of the present disclosure.

FIG. 2 illustrates a perspective view of the externally-hung lamp assembly in accordance with some embodiments of the present disclosure.

FIG. 3 illustrates a schematic view of a combination of a circuit board and a lamp cup of the externally-hung lamp assembly in accordance with some embodiments of the present disclosure.

FIG. 4 illustrates a schematic view of the externally-hung lamp assembly being sleeved on a screwdriver in accordance with some embodiments of the present disclosure.

FIG. 5 illustrates a perspective view of the externally-hung lamp assembly in accordance with some embodiments of the present disclosure.

FIG. 6 illustrates a schematic view of the externally-hung lamp assembly being hung to a coat pocket in accordance with some embodiments of the present disclosure.

FIG. 7 illustrates a schematic view of the externally-hung lamp assembly being hung to a waist belt in accordance with some embodiments of the present disclosure.

FIG. 8 illustrates a schematic view of the externally-hung lamp assembly being hung to a wall in accordance with some embodiments of the present disclosure.

FIG. 9 illustrates a schematic view of the externally-hung lamp assembly being attracted to a magnetic wall surface in accordance with some embodiments of the present disclosure

### DETAILED DESCRIPTION OF THE INVENTION

It is to be understood that the following disclosure provides many different embodiments or examples, for implementing different features of various embodiments. Specific examples of components and arrangements are described below to simplify the present disclosure. The present disclosure may, however, be embodied in many different forms and should not be construed as being limited to the embodiments set forth herein; rather, these embodiments are provided so that this description will be thorough and complete, and will fully convey the present disclosure to those of ordinary skill in the art. It will be apparent, however, that one or more embodiments may be practiced without these specific details.

In addition, the present disclosure may repeat reference numerals and/or letters in the various examples. This repetition is for the purpose of simplicity and clarity and does not in itself dictate a relationship between the various embodiments and/or configurations discussed.

It will be understood that when an component is referred to as being “on” another component, it can be directly on the other component or intervening components may be present. In contrast, when an component is referred to as being “directly on” another component, there are no intervening components present.

It will be understood that singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

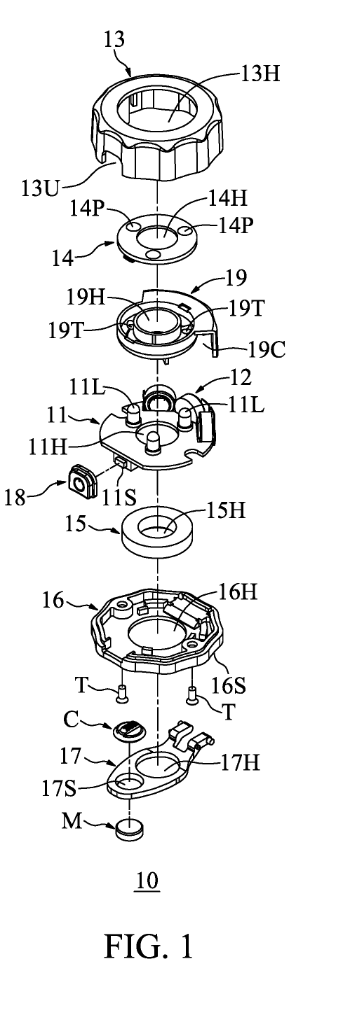

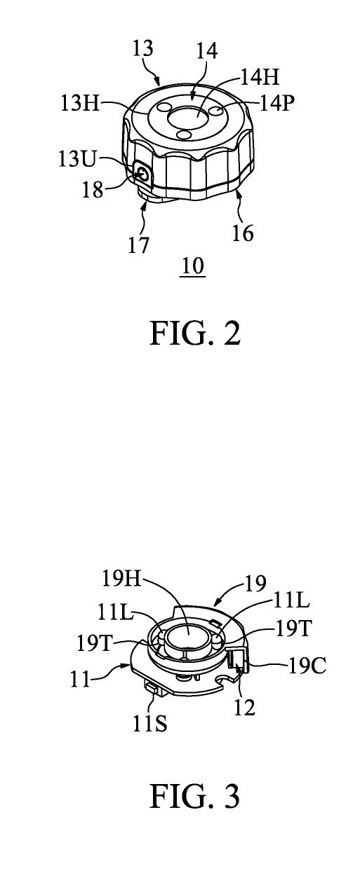

FIG. 1 illustrates an exploded perspective view of an externally-hung lamp assembly in accordance with some embodiments of the present disclosure. FIG. 2 illustrates a perspective view of the externally-hung lamp assembly in accordance with some embodiments of the present disclosure. Referring to FIGS. 1 and 2, an externally-hung lamp assembly 10 of the present disclosure includes a circuit board 11, a battery pack 12, an upper cover 13, a lampshade 14, a rubber ring 15, a lower cover 16, and a hook 17.

The circuit board 11 has a first hole 11H, a plurality of light-emitting components 11L, and a power switch 11S. In some embodiments, the light-emitting components 11L are LED lamps. The power switch 11S is configured to control on and off of the light-emitting components 11L.

The battery pack 12 is electrically connected to the circuit board 11, and is configured to provide power needed for turning on the light-emitting components 11L.

The upper cover 13 is disposed on the circuit board 11. The upper cover 13 has a second hole 13H, and the second hole 13H corresponds to the first hole 11H of the circuit board 11. In some embodiments, to prevent the upper cover 13 from affecting actuation of the power switch 11S, the upper cover 13 has a slot 13U, and the slot 13U is configured to expose the power switch 11S. Besides, to make the actuation of the power switch 11S be more smooth, in some embodiments, a switch button 18 can be disposed in the slot 13U, so as to actuate the power switch 11S.

The lampshade 14 is disposed in the second hole 13H of the upper cover 13. The lampshade 14 has a third hole 14H, and the third hole 14H corresponds to the first hole 11H of the circuit board 11. In some embodiments, the lampshade 14 has a plurality of lens portions 14P. Each of the lens portions 14P separately corresponds to each of the light-emitting components 11L, so as to focus light emitted by the light-emitting components 11L.

FIG. 3 illustrates a schematic view of a combination of a circuit board and a lamp cup of the externally-hung lamp assembly in accordance with some embodiments of the present disclosure. Referring to FIGS. 1 and 3, to position the light-emitting components 11L, in some embodiments, a lamp cup 19 can be disposed between the circuit board 11 and the lampshade 14. The lamp cup 19 has a sixth hole 19H, a plurality of through holes 19T, and an accommodation slot 19C. The sixth hole 19H corresponds to the first hole 11H of the circuit board 11. Each of the through holes 19T separately corresponds to each of the light-emitting components 11L, and each of the light-emitting components 11L separately penetrates through each of the through holes 19T, so as to achieve a positioning effect. In addition, to thin the externally-hung lamp assembly 10, the battery pack 12 is located in the accommodation slot 19C. Alternatively, in some embodiments, fabrication of the accommodation slot 19C can be omitted when the lamp cup 19 is fabricated, which can also achieve an effect of thinning the externally-hung lamp assembly 10.

Referring to FIG. 1 again, the rubber ring 15 is disposed beneath the circuit board 11. The rubber ring 15 has a fourth hole 15H, and the fourth hole 15H corresponds to the first hole 11H of the circuit board 11.

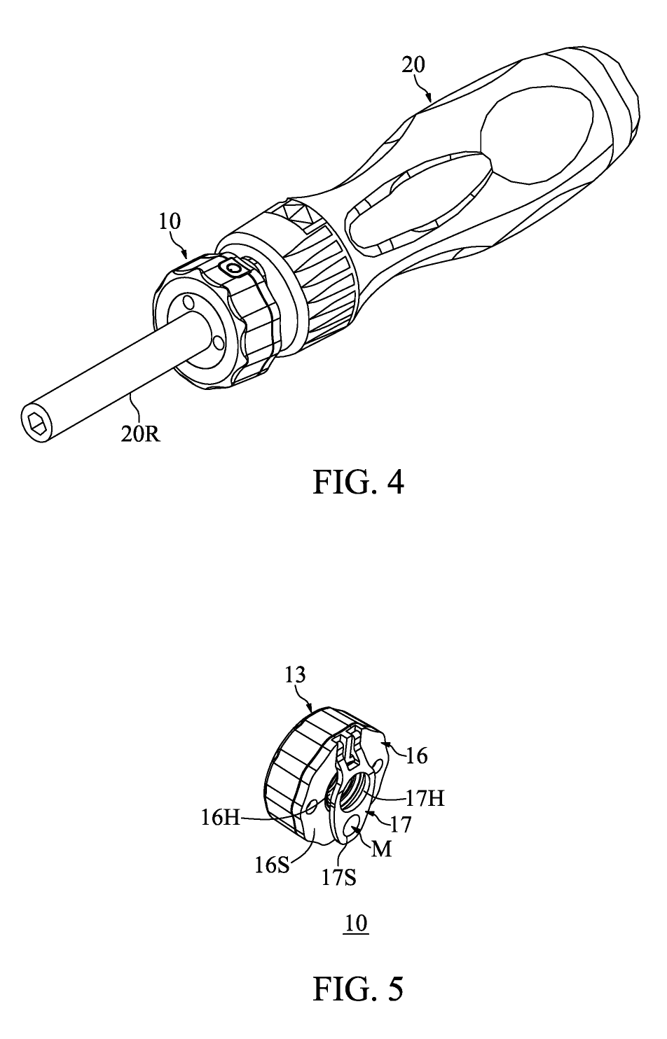

FIG. 4 illustrates a schematic view of the externally-hung lamp assembly being sleeved on a screwdriver in accordance with some embodiments of the present disclosure. Referring to FIGS. 1, 2 and 4, when the externally-hung lamp assembly 10 is sleeved on a rod portion 20R of a screwdriver 20, the rubber ring 15 can produce a force of friction, so as to prevent the externally-hung lamp assembly 10 from slipping from the rod portion 20R, and to achieve an effect of assisting illumination.

FIG. 5 illustrates a perspective view of the externally-hung lamp assembly in accordance with some embodiments of the present disclosure. Referring to FIGS. 1, 2 and 5, the lower cover 16 is combined with the upper cover 13. In some embodiments, the lower cover 16 is secured to the upper cover 13 by using a plurality of screws T. Preferably, the rubber ring 15 is located between the circuit board 11 and the lower cover 16.

Furthermore, the lower cover 16 has a back surface 16S and a fifth hole 16H, and the fifth hole 16H corresponds to the first hole 11H of the circuit board 11.

Referring to FIGS. 1 and 5 again, the hook 17 is pivotally disposed on the back surface 16S of the lower cover 16.

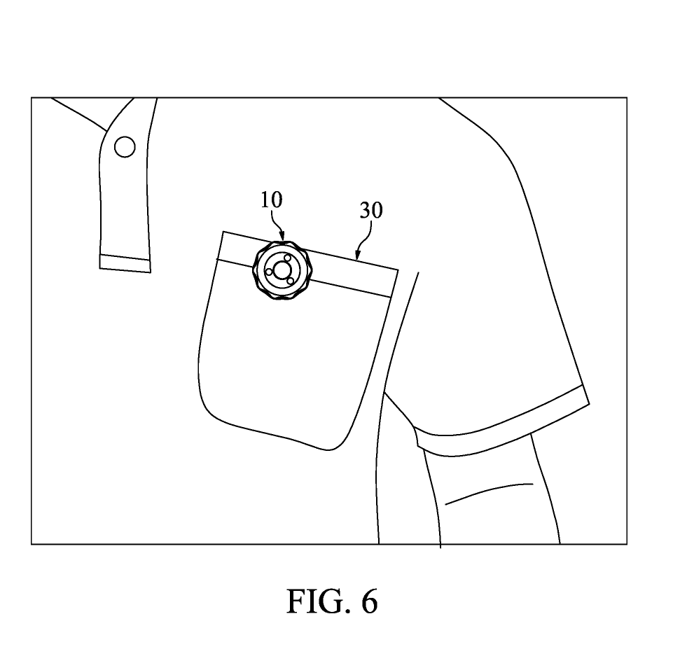

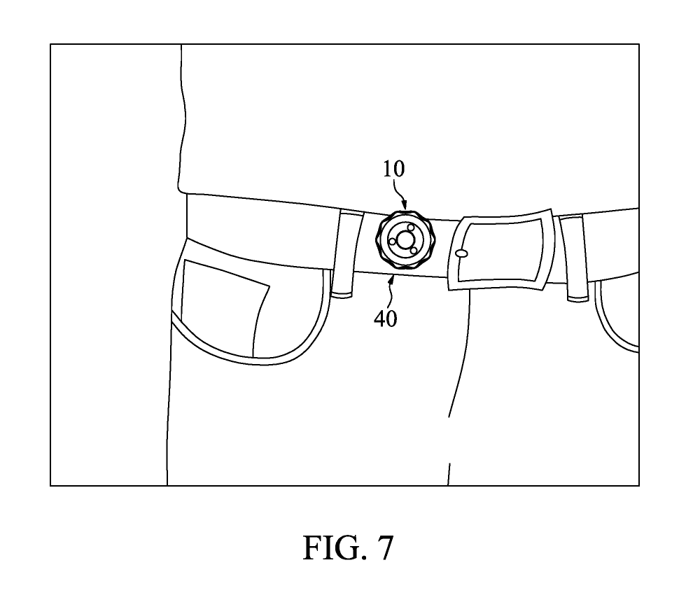

FIG. 6 illustrates a schematic view of the externally-hung lamp assembly being hung to a coat pocket in accordance with some embodiments of the present disclosure. FIG. 7 illustrates a schematic view of the externally-hung lamp assembly being hung to a waist belt in accordance with some embodiments of the present disclosure. Referring to FIGS. 5, 6 and 7, the externally-hung lamp assembly 10 of the present disclosure can be hung to a coat pocket 30 or a waist belt 40 by using the hook 17.

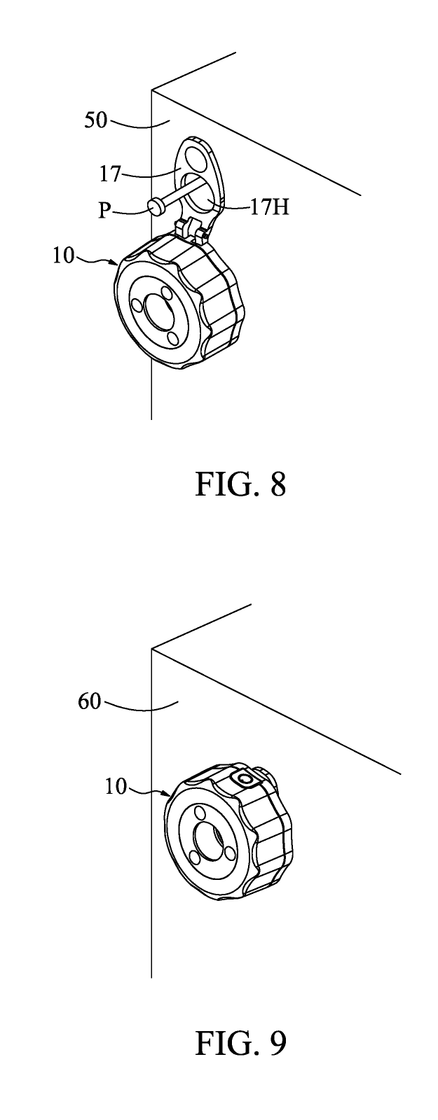

FIG. 8 illustrates a schematic view of the externally-hung lamp assembly being hung to a wall in accordance with some embodiments of the present disclosure. Referring to FIGS. 1, 5 and 8, to make the externally-hung lamp assembly 10 be hung to a wall 50, in some embodiments, the hook 17 has a hanging hole 17H. The hanging hole 17H is fitted with a nail P, so as to enable the externally-hung lamp assembly 10 to be successfully hung on the wall 50.

Referring to FIGS. 4 and 5 again, when the externally-hung lamp assembly 10 is sleeved on the rod portion 20R of the screwdriver 20, the hanging hole 17H needs to correspond to the fifth hole 16H of the lower cover 16.

FIG. 9 illustrates a schematic view of the externally-hung lamp assembly being attracted to a magnetic wall surface in accordance with some embodiments of the present disclosure. Referring to FIGS. 1, 5 and 9, to make the externally-hung lamp assembly 10 to be attracted to a magnetic wall surface 60, in some embodiments, a magnet component M can be disposed on the hook 17, so as to enable the externally-hung lamp assembly 10 to be attracted to the magnetic wall surface 60 by using the magnet component M. Preferably, the hook 17 has a slot 17S, and the magnet component M is disposed in the slot 17S. Furthermore, alternatively, a magnet cover C can be disposed at one side of the slot 17S, so as to protect the magnet component M. Preferably, the magnet cover C is located between the magnet component M and the lower cover 16.

By means of the description of the foregoing embodiments, the externally-hung lamp assembly 10 of the present disclosure can indeed meet configuration requirements of multiple different application scenarios.

Moreover, the scope of the present application is not intended to be limited to the particular embodiments of the process, machine, manufacture, and composition of matter, means, methods and steps described in the specification. As those skilled in the art will readily appreciate form the present disclosure, processes, machines, manufacture, compositions of matter, means, methods, or steps, presently existing or later to be developed, that perform substantially the same function or achieve substantially the same result as the corresponding embodiments described herein may be utilized in accordance with some embodiments of the present disclosure.

Accordingly, the appended claims are intended to include within their scope such processes, machines, manufacture, and compositions of matter, means, methods or steps. In addition, each claim constitutes a separate embodiment, and the combination of various claims and embodiments are within the scope of the invention.

What is claimed is:

1. An externally-hung lamp assembly, comprising:
a circuit board having a first hole and a plurality of light-emitting components;
a battery pack electrically connected to the circuit board and configured to provide power needed for turning on the light-emitting components;
an upper cover disposed on the circuit board, wherein the upper cover has a second hole corresponding to the first hole of the circuit board;
a lampshade disposed in the second hole of the upper cover, wherein the lampshade has a third hole corresponding to the first hole of the circuit board;
a rubber ring disposed beneath the circuit board, wherein the rubber ring has a fourth hole corresponding to the first hole of the circuit board;
a lower cover combined with the upper cover, wherein the lower cover has a back surface and a fifth hole corresponding to the first hole of the circuit board; and
a hook pivotally disposed on the back surface of the lower cover.

2. The externally-hung lamp assembly of claim 1, further comprising a lamp cup disposed between the circuit board and the lampshade.

3. The externally-hung lamp assembly of claim 2, wherein the lamp cup has a sixth hole corresponding to the first hole of the circuit board.

4. The externally-hung lamp assembly of claim 2, wherein the lamp cup has a plurality of through holes, and each of the through holes separately corresponds to each of the light-emitting components.

5. The externally-hung lamp assembly of claim 1, wherein the lampshade has a plurality of lens portions, and each of the lens portions separately corresponds to each of the light-emitting components.

6. The externally-hung lamp assembly of claim 1, wherein the rubber ring is located between the circuit board and the lower cover.

7. The externally-hung lamp assembly of claim 1, further comprising a magnet component disposed on the hook.

8. The externally-hung lamp assembly of claim 7, wherein the hook has a slot, and the magnet component is disposed in the slot.

9. The externally-hung lamp assembly of claim 8, further comprising a magnet cover disposed at one side of the slot and located between the magnet component and the lower cover.

10. The externally-hung lamp assembly of claim 1, wherein the hook has a hanging hole corresponding to the fifth hole of the lower cover.
